(19) United States
(12) Patent Application Publication
(10) Pub. No.: US 2011/0072350 A1
(43) Pub. Date: Mar. 24, 2011

(54) SYSTEMS AND METHODS FOR RECORDING AND SHARING AUDIO FILES

(76) Inventor: Walter Bachtiger, Novato, CA (US)

(21) Appl. No.: 12/878,014

(22) Filed: Sep. 8, 2010

Related U.S. Application Data
(60) Provisional application No. 61/244,096, filed on Sep. 21, 2009.

(51) Int. Cl. G06F 17/30; G06F 3/16; G10L 15/26

(52) U.S. Cl. 715/727; 707/741; 704/235; 707/E17.014; 704/E15.043

(57) ABSTRACT

Systems for recording and sharing audio files among a plurality of users. The systems include a server that is configured to receive, index, and store a plurality of audio files, which are received by the server from a plurality of sources, within at least one database in communication with the server. In addition, the server is configured to make one or more of the audio files accessible to one or more persons—other than the original sources of such audio files. Still further, the server is configured to receive and publish comments associated with the audio files within a graphical user interface of a website. The comments may be submitted to the server through the website by persons other than the original sources of such audio files.

### CROSS-REFERENCE TO RELATED APPLICATIONS

This application claims priority to, and incorporates by reference, U.S. provisional patent application Ser. No. 61/244,096, filed Sep. 21, 2009.

### FIELD OF THE INVENTION

The field of the present invention relates to systems and methods for recording, indexing, storing, and sharing audio files, including, but not limited to, recorded telephone conversations, internet communications, and other audio content.

### BACKGROUND OF THE INVENTION

Systems for recording and storing audio files have been available for many years and, indeed, are used by many individuals and businesses today. In addition, currently-available systems allow users to retrieve, either using a telephone or internet connection, audio files that may be stored in a database and correlated with a specific user of the system. Although these systems have become a ubiquitous part of communication (and communication management) in today's world, these systems do not efficiently capture, utilize, and make available to others, the value of the content stored within such audio files.

For example, currently-available systems do not efficiently allow users to share recorded audio files with other persons and, more importantly, publish comments regarding the content of a particular audio file for a plurality of other users to view. More particularly, such currently-available systems do not efficiently allow users to share and publish comments regarding specific and limited portions of the content of a particular audio file, for a plurality of other users to review. In addition, currently-available systems do not efficiently allow users to query a large body of different audio files for content that relates to a particular topic—or rank such audio files in order of relevance to a particular topic. Still further, currently-available communication management systems fail to adequately incentivize users to share, publish, and make available to others the audio files that may be recorded within a particular database used by such systems.

As described further below, the present invention addresses many of these, and other, drawbacks that are associated with currently-available audio storage and retrieval systems.

### SUMMARY OF THE INVENTION

According to certain aspects of the present invention, systems are provided for recording and sharing audio files among a plurality of users. More particularly, the systems generally comprise a server that is configured to receive, index, and store a plurality of audio files, which are received by the server from a plurality of sources, within at least one database in communication with the server. In addition, the invention provides that the server is configured to make one or more of the audio files accessible to one or more persons—other than the original sources of such audio files. In other words, if certain conditions are satisfied, the audio files that a first person records within the database of the system will be accessible by other persons. Still further, according to such embodiments of the invention, the server is preferably configured to receive and publish comments associated with specific portions of the audio files within a graphical user interface of a website. The invention provides that the comments may be submitted to the server through the website by persons other than the original sources (or authors) of such audio files. The audio files that are stored within the server may be derived from audio-only content (e.g., a telephone conversation) or, in certain cases, may comprise audio content derived from a video file (which has an audio component embedded therein).

According to additional aspects of the present invention, similar to the embodiments described above, systems for recording and sharing audio files are provided, which incentivize users of the system to share, publish, and make available to others the audio files that may be recorded within a particular database. According to such embodiments, the systems generally comprise a server that is configured to (a) receive, index, and store a plurality of audio files, which are received by the server from a plurality of sources, within at least one database in communication with the server; and (b) make one or more of the audio files accessible to persons other than the original sources (or authors) of such audio files.

According to such embodiments, the server is also configured to track the number of audio files shared by each user of the system. The invention provides that an audio file is considered “shared” when a user makes an audio file accessible to, or otherwise refers the audio file to, another user of the system. Still further, the invention provides that the server may, optionally, be configured to grant credit to each user of the system based on the number of audio files shared by each user during a defined period of time. According to such embodiments, the credit that is granted to each user may be redeemed, for example, in exchange for the right to use the system without charge (for a defined period of time) or other forms of consideration.

According to further aspects of the present invention, methods for recording, indexing, storing, and sharing audio files are provided, which generally comprise the use of the systems described herein.

The above-mentioned and additional features of the present invention are further illustrated in the Detailed Description contained herein.

### BRIEF DESCRIPTION OF THE FIGURES

FIG. 1 is a diagram showing the different components of the systems described herein.

FIG. 2 is a diagram showing the interactive nature and audio file sharing capability of the systems described herein.

FIG. 3 is a flow chart illustrating the controls provided by the systems described herein, which allow only specified users to access certain audio files and/or comments related thereto within the centralized website.

FIG. 4 is a diagram showing certain non-limiting components of an exemplary graphical user interface in which a user may query the content of a plurality of audio files, identify those audio files which include a certain key word (or set of key words) that the user defines, and quickly view the context in which such key word is used in one or more audio files.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

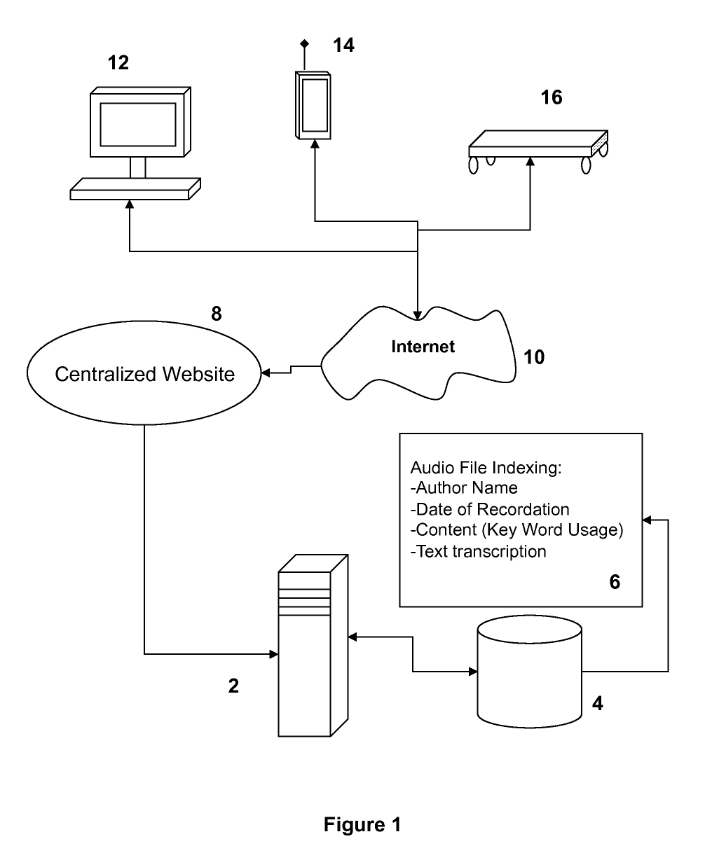

According to certain preferred embodiments, the present invention generally encompasses systems for recording and sharing audio files among a plurality of users. Referring to FIG. 1, the systems generally comprise a server 2 that is configured to receive, index, and store a plurality of audio files, which are received by the server 2 from a plurality of sources, within at least one database 4 in communication with the server 2. The invention provides that the database 4 may reside within the server 2 or, alternatively, may exist outside of the server 4 while being in communication therewith via a network connection.

The audio files may be indexed 6 and categorized within the database 4 based on author, time of recordation, geographical location of origin, IP addresses, language, key word usage, combinations of the foregoing, and other factors. The invention provides that the audio files are preferably submitted to the server 2 through a centralized website 8 that may be accessed through a standard internet connection 10. The invention provides that the website 8 may be accessed, and the audio files submitted to the server 2, using any device that is capable of establishing an internet connection 10, such as using a personal computer 12 (including tablet computers), telephone 14 (including smart phones, PDAs, and other similar devices), meeting conference speaker phones 16, and other devices. The invention provides that the audio files may be created by such devices and then uploaded to the server 2 or, alternatively, the audio content may be streamed in real time (through such devices) with the audio file being created (and then indexed and stored) within the server 2 and database 4. In addition, the invention provides that the audio files that are stored within the server 2 and database 4 may be derived from audio-only content (e.g., a telephone conversation) or, in certain cases, may comprise audio content derived from a video file (which has an audio component embedded therein).

The invention provides that the server 2 may receive and manage audio files in many ways, such that the contents thereof may be deciphered and used as described herein. For example, the invention provides that upon an audio file being submitted to the server 2, the server 2 may perform a speech-to-text, speech-to-phoneme, speech-to-syllable, and/or speech-to-subword conversion, and then store an output of such conversion within the database 4. This way, the content of each audio file may be intelligently queried and used in the manner described herein, such as for querying such content for key words.

The invention provides that when reference is made to “audio files that contain a key word,” and similar phrases, it should be understood that such phrase encompasses a text file that contains the key word, with the text file being derived from an audio file, as explained above. In other words, for example, after performing a speech-to-text conversion, and storing such text within the database 4, if a search is performed using the system of the present invention for audio files that contain a particular key word, the system will actually search the converted text forms of such audio files. Upon identifying any text forms of such audio files that contain the queried key word, it will be inferred that the audio file that corresponds with the searched text file will actually contain the key word.

The audio file that is provided to the server 2 and database 4 may represent and be derived from, for example, a recorded telephone conversation, VoIP conversation, group meeting (through a speaker phone), speech or lecture (through a microphone), deposition or court room testimony (through a court reporter's microphone and/or transcript data entry), and other audio sources. The invention provides that the system described herein is preferably compatible with, and capable of receiving audio files from, any devices that may be used among persons to communicate, to transmit communications, or to record communications. In general, the invention provides that such devices may record the audio file, which may be then be submitted to the server 2 as described herein. In other embodiments, the invention provides that the system may include a recordation means which records, in real time, an audio file that is representative of (and streamed from) a conversation between two or more people using, for example, a cellular telephone or other electronic communication devices.

When the present specification refers to the server 2, the invention provides that the server 2 may comprise a single server or a group of servers. In addition, the invention provides that the system may employ the use of cloud computing, whereby the server paradigm that is utilized to support the system of the present invention is scalable and may involve the use of different servers (and a variable number of servers) at any given time, depending on the amount of users who are utilizing the system at different time points, which are in fluid communication with the database 4 described herein.

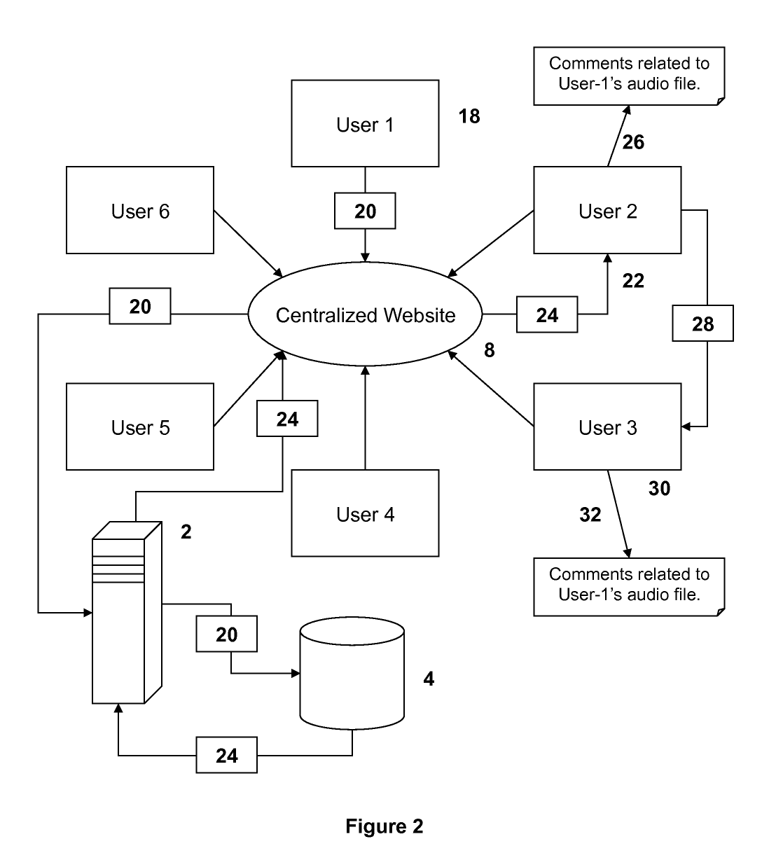

According to certain preferred embodiments, the invention provides that the server 2 is configured to make one or more of the audio files accessible to persons other than the original source (or author) of the audio files. The invention provides that the term “source” refers to a person who is responsible for uploading an audio file to the server 2, whereas the term “author” refers to one or more persons who contributed content to an uploaded audio file (who may, or many not, be the same person who uploads the audio file to the server 2). For example, referring now to FIG. 2, a first user (User-1) 18 may submit 20 an audio file to the server 2 through the centralized website 8, which is then indexed and stored within a database 4. The invention provides that if certain conditions are satisfied, as described below, the audio files that the first user (User-1) 18 records within and uploads to the database 4 will then be accessible by other persons. For example, a second user (User-2) 22 may retrieve 24 and listen to User-1's audio file from the database 4 through the centralized website 8.

Upon retrieving and accessing User-1's audio file, User-2 22 may publish comments 26 regarding User-1's audio files within a graphical user interface of the website 8. Moreover, User-2 22 may publish comments 26 regarding certain limited portions of User-1's audio files, with the relative location of such comments being quickly ascertainable within the graphical user interface of the website 8. The invention provides that the comments 26 may be submitted to the server 2 through the website 8 by User-2 22, or any other persons who are granted access to User-1's 18 original audio files. The invention provides that the comments 26 will be associated with User-1's 18 original audio files within the database 4, along with other information collected by the server 2, such as the identity of the user/person submitting the comments 26, the date and time of submission, and/or other relevant information.

The invention further provides that the comments 26 may be viewed by any person accessing the website 8 or, alternatively, a limited group of persons who are granted access to User-1's 18 original audio files. For example, an author of an audio file, and/or the person (source) who submits an audio file to the server 2, may submit instructions to the server 2 which only allow certain persons to access and listen to the audio file. The invention provides that such access controls may be used if a user (or author or source of an audio file) does not want an audio file to be generally available to all users of the system.

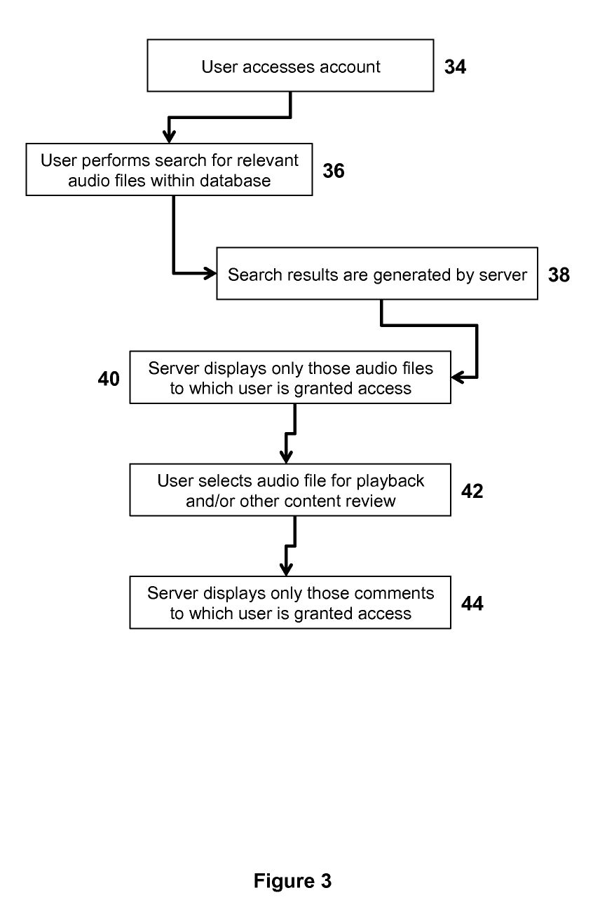

Referring to FIG. 3, for example, the invention provides that a user may access his/her account 34, by providing the server 2 with an authorized username/password through the centralized website 8. The user may then perform a search 36 of the database 4 for desired audio files, namely, audio files containing one or more search terms (key words), as described herein. The invention provides that the server 2 will then generate a list of results 38, i.e., audio files that contain one or more of the queried search terms, and then display (within the centralized website 8) only those audio files to which the user is granted access 40. The user may then select one or more audio files within the viewable search results for playback and/or other content review 42. In addition, upon selecting an audio file from the search results within the centralized website 8, the server 2 will display only those comments (related to the selected audio file) that the user is allowed to view 44. In other words, the individuals who publish comments regarding an audio file may further limit access to such comments to only authorized users of the system.

Referring now to FIG. 2, according to certain preferred embodiments, the invention provides that a user of the system, such as User-2 22, may refer 28 an audio file (with or without comments 26 associated therewith) to another user. When the other user, e.g., User-3 30, receives notice of such referral 28, the other user may access and listen to the referred audio file and, optionally, publish comments 32 regarding User-1's audio files within a graphical user interface of the website 8. In addition, the invention provides that users of the system may share, refer, and transmit to other users a limited portion of one or more audio files. For example, if a first user determines that a second user may find a particular portion of an audio file to be of interest, the first user may refer only the interesting portion of that audio file to the second user. According to such embodiments, the invention provides that the graphical user interface of the website 8 may include certain controls which allow a user to excise portions of an audio file and refer the same to another user, e.g., by using time coordinates associated with an audio file, from beginning to end, to identify and refer only the relevant portion of an audio file to another user of the system.

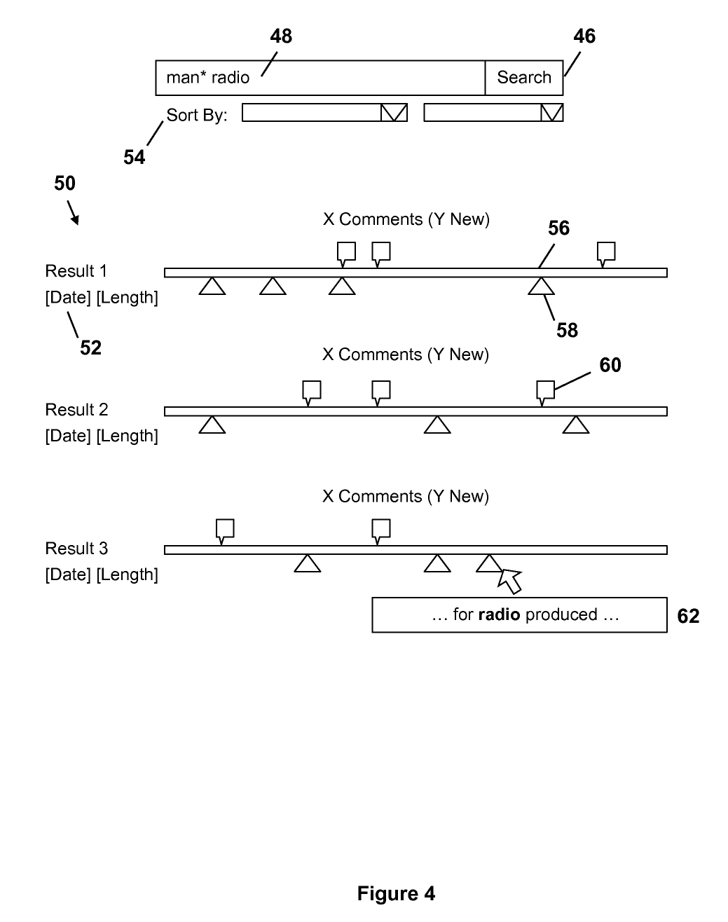

As mentioned above, according to certain preferred embodiments of the present invention, the system is configured to allow users to query the database 4, preferably through the website 8, for audio files that include within the content thereof one or more key words. A non-limiting example of a portion of a graphical user interface showing an exemplary search function 46 is provided in FIG. 4. More particularly, the invention provides that the server 2 of the system may be configured to receive one or more key words 48 that are submitted by a user of the system through the website 8, whereupon the server 2 queries the database 4 to identify all audio files which include the one or more key words 48. The invention provides that the system, and search function 46, may employ Boolean search logic, e.g., by allowing conjunctive and disjunctive searches, truncated and non-truncated forms of key words, exact match searches, and other forms of Boolean search logic.

The server 2 may then present the search results 50 to the user within the website 8 and, preferably, list all responsive audio files in a defined order within such graphical user interface, but only those audio files to which the user has been granted access, as described above. For example, the search results may list the audio files in chronological order based on the date (and time) 52 that each audio file was recorded and provided to the database 4. In other embodiments, the audio files may be listed in an order that is based on the number of occasions that a key word is used within each audio file. These criteria, combinations thereof, or other criteria may be employed to list the responsive audio files in a manner that will be most relevant to the user. Still further, the invention provides that a user may specify the criteria that should be used to rank (and sort) the search results, with such criteria preferably being selected from a predefined list 54.

Still referring to FIG. 4, each audio file included within a set of search results will preferably be graphically portrayed, such as in the form of a line 56 that begins at time equals zero (t=0) and ends at a point when the audio file is terminated. For example, if the total length of an audio file is five minutes, the left side of the line will be correlated with t=0 of the audio file, whereas the right side of the line will be correlated with t=5 minutes of the audio file. Still further, the invention provides that the location of each search term that was queried may be indicated along the line 56. For example, the location of each search term may be indicated with a triangle 58, or other suitable and readily visible element. The invention further provides that if multiple search terms were used in the search, the line 56 may be annotated with multiple triangles 58 (or other suitable elements), each of which may exhibit a different color that is correlated with a particular search term. More particularly, for example, if two search terms are used, the line 56 may be annotated with triangles 58 (or other suitable elements), which exhibit one of two colors, with one color representing a location of a first search term and a second color indicating the location of a second search term.

The invention further provides that each line 56 that represents a relevant audio file may be annotated with one or more comments 60 posted by other users, as described herein. The invention provides that such annotation of the comments 60 will preferably indicate the location within the audio file to which each comment 60 relates. According to yet further embodiments, the invention provides that when a user places a cursor (within the centralized website 8) over or in the near vicinity of a triangle 58 (or other element indicating the location of a search term) or a comment 60, the graphical user interface of the website 8 will automatically publish a temporary text box 62 in which the search term may be viewed, along with a limited number of words before and after the search term (i.e., the context in which the search term is used).

The invention provides that the text box 62 will allow a user to quickly review the context in which the search term is used, which will facilitate knowing whether the audio file (or a portion thereof) may be relevant to the user and worthy of playback and/or further review. According to certain embodiments, the invention provides that a user may, optionally, control the number of words appearing before and after the search term in the text box 62, by entering the desired number of words in a specified field within the user's dedicated account page. This way, each user may adjust the size of the text box 62 in accordance with his/her personal preferences.

According to certain embodiments, the invention provides that a limited number of fields within the database 4 (which are associated with a particular audio file) may be pre-filled by an audio recording device. For example, the invention provides that the title and description fields (within the database 4) that are associated with an audio file may be pre-filled with information that is sourced from the calendar entries stored within, for example, a mobile phone of the user that is submitting the audio file (through the mobile phone) to the server 2 and database 4. For purposes of illustration, when the user submits an audio file to the server 2 and database 4 through a mobile phone, the system will automatically query any calendar entries stored within the phone and transmit relevant information to the appropriate fields of a database 4 entry that is created for the audio file, such as the audio file title, the names of the persons who contributed to the content of the audio file, date and time of recordation, and/or other relevant information. According to such embodiments, the automatically-filled data fields would be editable by the user, in order to make any necessary corrections thereto. The invention provides that similar functionality may be implemented using other recording means, such as internet-mediated communication portals (which may allow the system to automatically query emails and/or calendar programs stored within a personal computer).

The invention provides that the system described herein will allow users to identify other users who, based on the frequency of certain key word usage, may be experts or knowledgeable regarding a particular topic. For example, the database 4 may be queried for other users who have submitted one or more audio files which include the word “golf,” with the search results being listed in the website 8—e.g., the names (or usernames) of such users who satisfy the search criteria. The invention provides that this search functionality will be useful for identifying persons who may be knowledgeable about a particular topic. The search results may be listed in an order that is most relevant to the user, such as by ranking the users who use the search term most often—either relatively or absolutely—and/or based on geographical proximity to the user who initiated the search.

According to certain embodiments, the system may further communicate with one or more social networking sites, such as LinkedIn, MySpace, Facebook, and others. Referring to the example above, when a user submits a key word search as described above, the system will not only list the users (usernames) who have submitted at least one audio file which includes the word “golf,” it may also query the communications (i.e., audio files stored within the server 2 and database 4) of those users' “friends” and/or “friends-of-friends,” as listed in the associated social networking sites, who have also submitted audio files to the server 2 and database 4. This way, a user may quickly identify a group of people who may be knowledgeable about a particular topic. Still further, if the key word is a person's name (or social network username), such functionality would allow users of the system to easily identify other users who may know, or be related to, the person identified by the key word search.

According to further embodiments of the present invention, the audio files provided to the server 2 and database 4 by each user may be automatically queried for certain key words included therein. More particularly, the system may query each audio file to determine whether any words included therein are found in a pre-recorded list of advertising terms. If such analysis reveals that any of the words included within the audio files match any of the pre-recorded advertising terms, the server 2 may cause a relevant advertisement to be posted within the graphical user interface of the website 8 when the user accesses the website 8. Referring to the example above, if a user uploads an audio file to the database 4 which includes (in the transcript of the audio content thereof) the word “golf,” the server 2 may published one or more golf-related advertisements in the graphical user interface of the website 8. According to such embodiments, the invention provides that the server 2 will be in communication with one or more databases that correlate certain terms with one or more advertisements.

In addition, the invention provides that whether certain advertisements are posted within the website 8 may be determined not only on whether a particular user's audio file includes a certain key word, but also (1) the number of times that such key word is used within an audio file, (2) the number of distinct audio files provided by the same user over a period of time that includes the key word, or (3) combinations of the foregoing. For example, if the system detects that a particular user has submitted a certain minimum number of audio files to the database 4 which include the word “golf” (and not just a single audio file that contains such term), the server 2 may cause one or more advertisements related to golf products or golf services to be published in the website 8—when the user visits the website 8 (with the publication of the advertisement being triggered based on the user's IP address) and/or when the user submits a valid username/password to login to the website 8. In addition, the invention provides that other criteria may be employed to determine which advertisement(s) to display, such as the location in which the audio file is recorded (e.g., the geographic location may be communicated to the server 2 if a mobile device is used to capture the audio recording), the level of background noise, the quality of the audio file, the type of recording device used, and/or other information and data that may be retrieved by the server 2 regarding a user, an audio file or the contents thereof.

Still further, the invention provides that advertisements may be posted within the graphical user interface of the website 8 based on the key words that may be used by a particular user to query the database 4 for relevant audio files. For example, using the example described above, if a user queries the database 4 for audio files that include the word “golf,” the server 2 may search for and determine if the word “golf” matches any terms included within a pre-recorded list of advertising terms and, if so, the server 2 will cause one or more advertisements related to golf products or golf services to be published in the website 8.

According to additional and related embodiments of the present invention, similar to the embodiments described above, systems for recording and sharing audio files are provided, which incentivize users of the system to share and publish comments regarding the audio files described herein. In other words, such embodiments are designed to encourage users to distribute, and make publicly available, the audio files recorded by each user and, in the case of referrals, the audio files recorded by other users. For example, as described above, these systems will generally comprise a server 2 that is configured to receive, index, and store a plurality of audio files—which are received by the server 2 from a plurality of sources—within at least one database 4 in communication with the server 2.

In addition, as described above, the system will preferably make one or more of the audio files accessible to persons other than the original sources (author) of such audio files. In other words, the system will preferably allow users to share, exchange, and publish comments regarding the plurality of audio files recorded within the database 4 and managed by the system. According to such embodiments, the server 2 may also be configured to track the number of audio files shared by each user of the system. The invention provides that an audio file is considered “shared” when a user makes an audio file accessible to, or otherwise refers the audio file to, another user of the system.

For example, the invention provides that the system may be configured to enable a user to send (such as via e-mail) to another user, directly or indirectly, a hyperlink to the website 8 or a location therein where a particular audio file may be accessed—such that the receiving user may listen to and optionally submit comments regarding the audio file. In other embodiments, the referring or sharing user may provide instructions to the server 2 that are housed within the database 4, which provide that certain audio files submitted to the server 2 by the referring or sharing user may only be accessed by another user (or set of users) specified by the sharing or referring user. Such lists of authorized users, who may access a particular audio file, may also be configured and communicated to such authorized users as an invitation to access, listen to, and submit comments regarding a particular audio file. As described above, the system may be configured to track the number of audio files shared in such manner by each user of the system.

Still further, according to such embodiments, the invention provides that the server 2 may, optionally, be configured to grant credit to each user of the system based on the number of audio files shared or referred by each user during a defined period of time. According to such embodiments, the credit that is granted to each user may be redeemed for a variety of items, such as money, gift certificates, gift cards, the right to use the system without charge for a defined period of time, or other items. The invention provides that such credit system will preferably encourage audio file sharing among users of the system. The invention provides that the website 8 may include an account page for each user, which lists the amount of accumulated credit that has been awarded to each user at any given time (and, optionally, may further display credit that has been redeemed by the user of the system).

According to still further embodiments of the present invention, methods for recording, indexing, storing, sharing, and publishing comments regarding audio files are provided, which generally comprise the use of the systems described herein.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A system for recording and sharing audio files, which comprises a server that is configured to:
(a) receive, index, and store a plurality of audio files, which are received by the server from a plurality of sources, within at least one database in communication with the server;
(b) make one or more of the audio files accessible to persons other than the sources of such audio files; and
(c) receive and publish comments associated with the audio files within a graphical user interface of a website, wherein the comments are submitted to the server through the website by the persons other than the sources of such audio files.

2. The system of claim 1, wherein the server is further configured to:
(a) receive a key word that is submitted by a user of the system through the website, whereupon the server queries the database to identify all audio files which include the key word; and
(b) list all audio files that include the key word in a defined order within the graphical user interface of the website.

3. The system of claim 2, wherein the defined order may (a) list the audio files in chronological order based on a date of recordation in the database for each audio file, (b) list the audio files based on a number of occasions that the key word is used in each audio file, or (c) combinations of the foregoing.

4. The system of claim 3, wherein the audio files provided to the server by each user are automatically queried; words included within the audio files are compared to a list of pre-recorded advertising terms; and, if any of the words included within the audio files match any of the pre-recorded advertising terms, an advertisement is posted within the graphical user interface of the website when the user accesses the website.

5. The system of claim 3, wherein upon an audio file being submitted to the server, the server performs a speech-to-text, speech-to-phoneme, speech-to-syllable, or speech-to-subword conversion and stores an output of such conversion within the database.

6. The system of claim 5, wherein an audio file may represent a recorded telephone conversation, VoIP conversation, group meeting, speech, or lecture.

7. The system of claim 6, wherein the website comprises a graphical user interface that portrays a beginning and an end of each audio file, and a location of each key word contained therein.

8. The system of claim 7, wherein the website is configured to display a text box in which a key word and surrounding context is shown upon placing a cursor over an element that indicates the location of a key word contained in the audio file.

9. A system for recording and sharing audio files, which comprises a server that is configured to:
(a) receive, index, and store a plurality of audio files, which are received by the server from a plurality of sources, within at least one database in communication with the server;
(b) make one or more of the audio files accessible to persons other than the sources of such audio files;
(c) track a number of audio files shared by each user of the system, wherein an audio file is shared when a user makes the audio file accessible to another user of the system; and
(d) grant credit to each user of the system based on the number of audio files shared during a defined period of time by each user.

10. The system of claim 9, wherein a pre-defined amount of credit affords a user an ability to use the system without charge for a defined period of time.

11. The system of claim 10, wherein the server is further configured to:
(a) receive a key word that is submitted by a user of the system through the website, whereupon the server queries the database to identify all audio files which include the key word; and
(b) list all audio files in a defined order within the graphical user interface of the website.

12. The system of claim 11, wherein the defined order may (a) list the audio files in chronological order based on a date of recordation for each audio file, (b) list the audio files based on a number of occasions that the key word is used in each audio file, or (c) combinations of the foregoing.

13. The system of claim 12, wherein the audio files provided to the server by each user are automatically queried; words included within the audio files are compared to a list of pre-recorded advertising terms; and, if any of the words included within the audio files match any of the pre-recorded advertising terms, an advertisement is posted within the graphical user interface of the website when the user accesses the website.

14. The system of claim 13, wherein upon an audio file being submitted to the server, the server performs a speech-to-text, speech-to-phoneme, speech-to-syllable, or speech-to-subword conversion and stores an output of such conversion within the database.

15. The system of claim 14, wherein an audio file may represent a recorded telephone conversation, VoIP conversation, group meeting, speech, or lecture.

16. A method for recording and sharing audio files, which comprises:
(a) receiving within a server a plurality of audio files, which are provided to the server from a plurality of sources, and storing and indexing said audio files within at least one database in communication with the server;
(b) allowing one or more of the audio files to be accessible to persons other than the sources of such audio files; and
(c) receiving and publishing comments associated with the audio files within a graphical user interface of a website, wherein the comments are submitted to the server through the website by the persons other than the sources of such audio files.

17. The method of claim 16, which further comprises:
(a) receiving, within the server, a key word that is submitted by a user of the website, whereupon the server queries the database to identify all audio files which include the key word; and
(b) listing all audio files that include the key word in a defined order within the graphical user interface of the website.

18. The method of claim 17, which further comprises instructing the server to perform a speech-to-text, speech-to-phoneme, speech-to-syllable, or speech-to-subword conversion of each audio file uploaded to the server, and storing an output of such conversion within the database.

19. The method of claim 18, which further comprises portraying a beginning and an end of each audio file that comprises a key word within a graphical user interface of the website, and a location of each key word within each such audio file.

20. The method of claim 19, which further comprises displaying a text box in which a key word and surrounding context is shown upon placing a cursor over an element that indicates the location of a key word contained in each audio file.
